(19) United States
(12) Patent Application Publication
(10) Pub. No.: US 2011/0297003 A1
(43) Pub. Date: Dec. 8, 2011

(54) Automatic Coffee Maker with Cup Warmer(s) (aka) - also known as automatic coffee maker with cup/decanter warmer(s)

(76) Inventor: Tommie Hawkins, JR., Fort Worth, TX (US)

(21) Appl. No.: 13/154,535

(22) Filed: Jun. 7, 2011

Related U.S. Application Data
(60) Provisional application No. 61/397,196, filed on Jun. 8, 2010.

(51) Int. Cl. A47J 31/02

(52) U.S. Cl. 99/288

(57) ABSTRACT

An improved coffee making machine is shown which includes a coffee brewing base having a central warmer and a tower portion for dispensing brewed coffee through a filter and into a decanter located on the central warmer. A power source provides electrical power to the base and to the tower portion and to the central warmer. One or more retractable cup/decanter warmers are movable between a closed position totally concealed within the base and a warming position which is visible and extended from the base. Each retractable cup/decanter warmer can be securely locked into position in the warming position, which then allows a heating element located on the warmer to engage with the power source to provide heating to a cup or decanter of coffee.

### CROSS REFERENCE TO RELATED APPLICATIONS

The present application claims priority from a previously filed provisional application Ser. No. 61/397,196, filed Jun. 8, 2010, entitled “Automatic Coffee Maker With Cup Warmer(s) (aka)—also known as automatic coffee maker with cup/decanter warmers(s),” by the same inventor.

### BACKGROUND OF THE INVENTION

1. Field of the Invention

The present invention relates generally to automatic coffee brewing machines and to accessory components and methods associated with such machines for warming coffee cups and decanters of coffee.

2. Description of the Prior Art

There are a number of prior art coffee making machines known in the prior art, including machines which have multiple warming surfaces.

For example, U.S. Pat. No. 4,825,757, issued May 2, 1989, to Stoner, in FIG. 1 thereof shows a coffee brewing machine and a decanter warmer plate. The written description states that such coffee brewing machines of the past “may have included up to four warmer plates 32 evenly distributed on a top shelf 34 and a bottom shelf 36. The top and bottom shelves 34, 36 were integrally connected to a housing 38 which enclosed a separate system for directing heated water through a retainer assembly 40 for holding fresh coffee grounds . . . ”

U.S. Design Pat. No. 352,421, issued Nov. 15, 1994, to Newnan; U.S. Design Pat. No. 491,012, issued Jun. 8, 2004, to Rogers; and U.S. Design Pat. No. 585,230, issued Jan. 27, 2009, to Webster et al., all show coffee decanter warmers with multiple warming surfaces.

Each of the above coffee warming and brewing machines was basically intended for a business setting, such as for a coffee shop, diner, restaurant, etc. They were not generally intended for use in a smaller setting such as a home or office board room or the like. The decanter warming surfaces are permanently fixed in place, making the devices take up a good deal of counter space. They are also rather unappealing in appearance, having a general institutional type appearance.

Thus, there continues to exist a need for improved automatic coffee brewing machines and particularly to such machines having integral accessory trays for warming coffee cups and decanters of coffee.

A need also exists for such an improved design which is relatively simple to implement using commonly available components and materials.

A need also exists for such an improved design which is esthetically pleasing in appearance and design.

### SUMMARY OF THE INVENTION

An improved coffee making machine is shown which features a coffee brewing base having a central warmer and a tower portion for dispensing brewed coffee through a filter and into a decanter located on the central warmer. A power source provides electrical power to the base and to the tower portion and to the central warmer. At least one retractable cup/decanter warmer is slidable between a closed position totally concealed within the base and a warming position which is visible and extended from the base. The retractable cup/decanter warmer can be securely locked into position in the warming position, which then allows at least one heating element located on the warmer to engage the power source. Preferably, there are provided left-side and right-side warmers which are secured with the heating elements engaged only when the warmers are fully extended and secured by a suitable locking mechanism which serves to lock-in-place the retractable warmers.

In a preferred configuration, the cup/decanter warmers are circumferentially mounted within a casing which contours to the shape of the coffee maker and are housed in either side of the base of the coffee maker by means of seamless side-seams.

The cup/decanter warmers and are only viewed once they are moved to an open position, preferably by the push of a button for single or dual usage. These features allow a user to warm cups of coffee during brewing and after the brewing cycle, thereby allowing the user to keep coffee or other liquids hot in one or more decanters after brewing. They also allow the user either single or dual cup warming, and single or dual decanter warming during and after brewing.

Preferably, the cup/decanter warmers will only securely retract into the base of the coffee maker after the heating elements are cool, this action serving to tighten and secure the retractable warmers in the base of the coffee making machine where they are safely stored.

The cup/decanter warmers can also be provided as detachable units which can be detached from the coffee machine base by pulling out a plug, or the like.

Additional objects, features and advantages will be apparent in the written description which follows.

### BRIEF DESCRIPTION OF THE DRAWINGS

FIG. 1 is a perspective view of a coffee making machine of the invention with its warming trays in the open position.

FIG. 2 is a view similar to FIG. 1 of the coffee making machine of the invention, but with one coffee decanter in place on the tower and another decanter in place on an extended warming tray.

FIG. 3 is view similar to FIG. 1, but showing a detachable warming tray.

### DETAILED DESCRIPTION OF THE INVENTION

The embodiments herein and the various features and advantageous details thereof are explained more fully with reference to the non-limiting embodiments that are illustrated in the accompanying drawings and detailed in the following description. Descriptions of well-known components and processes and manufacturing techniques are omitted so as to not unnecessarily obscure the embodiments herein. The examples used herein are intended merely to facilitate an understanding of ways in which the invention herein may be practiced and to further enable those of skill in the art to practice the embodiments herein. Accordingly, the examples should not be construed as limiting the scope of the claimed invention.

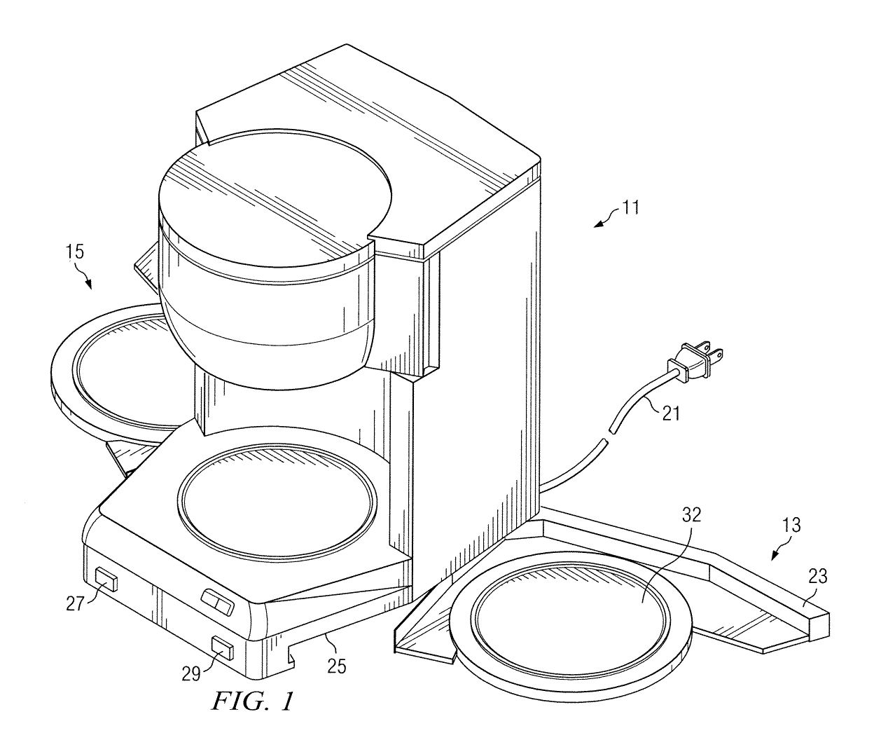

FIG. 1 is a perspective view taken from the Inventor's Auto CADD drawings showing the Frontal-Side view of the Automatic Coffee Maker With Cup Warmer(s) (aka)—also known as automatic coffee maker with cup/decanter warmers(s) of the invention, designated generally as 11. The apparatus is provided with the right-side 13 and left-side cup/decanter warmers 15 constructed in accordance with the invention.

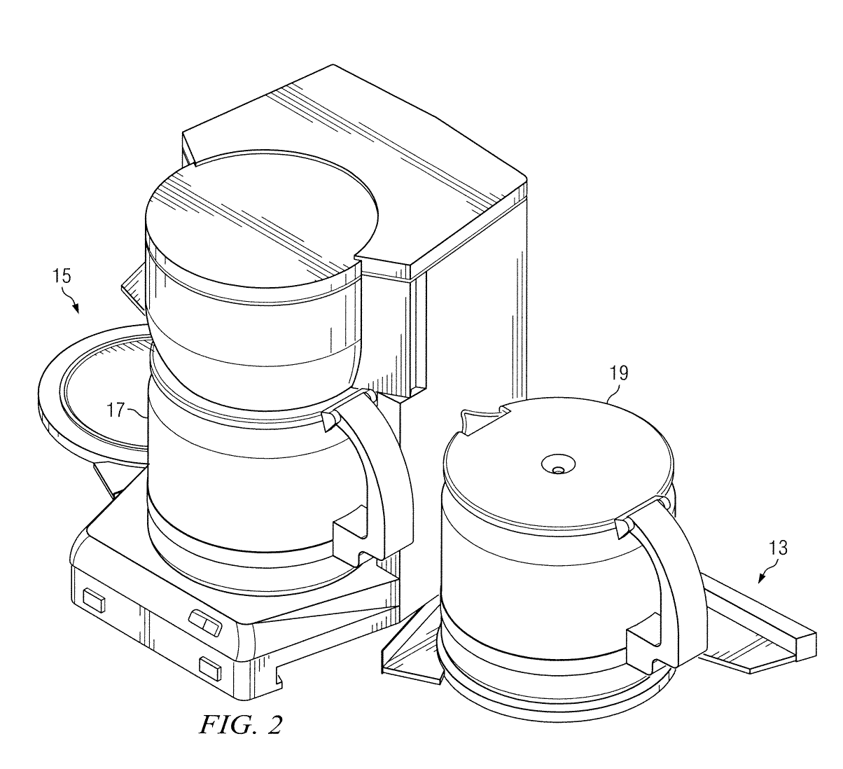

FIG. 2 is a frontal-side perspective taken from inventor's auto CADD drawings showing the automatic coffee maker of FIG. 1, and with cup/decanter warmers of both the left-side 15 and right-side cup/decanter warmers 13 shown, but with a decanter 17 on the center warmer and a decanter 19 in the center of the right-side cup/decanter warmer. The front-side perspective view shows the left-side warmer fully extended and the right-side warmer fully extended with a decanter on the warmer with the associated heating element engaged only when the warmers are fully extended and secured by their respective lock-in place retractable warmer mechanisms.

Once fully extended, the retractable/cup/decanter warmers of the invention securely lock into place, which then allows the heating element to engage. This could be accomplished in a number of convenient ways, for example, with a spring loaded detent, or other type of engageable switch. The switch would only engage when the warming tray was fully extended, thereby allowing power from the power source (indicated as the power cord 21 in FIG. 1) to reach the resistive heating element in the warming tray. See, in this regard, U.S. Pat. No. 3,978,238, issued Aug. 31, 1976, to Frey et al., which shows one configuration of a safety electrical interlock system for a food warmer, the disclosure of which is incorporated herein by reference.

As can be seen in FIG. 1, each of the cup/decanter warmers are circumferentially mounted within a casing 23 which contours to the shape of the coffee maker base 25 and are housed in either side base of the coffee maker by means of seamless side-seams and are only viewed once opened by a push of a button (such as buttons 27, 29 in FIG. 1) for single or dual usage. Each of the warmers is preferably provided with a non-stick surface (such as surface 32 in FIG. 1) so that cups or decanters will not stick easily to the surface.

These features allow the user to warm cups during brewing and after the brewing cycle, and allow the user to keep coffee or liquids hot in one or more decanters after brewing. These features allow the user single or dual cup warming, and single or dual decanter warming during and after brewing. Each cup/decanter warmer will preferably only securely retract into housing base of the coffee maker after the heating elements are cool. This action then tightens and secures the retractable warmers in the housing side-base areas where they are safely stored.

Preferably, the resistive heating elements of the cup/decanter warmers will be automatically turned off after a predetermined period of time, for example one or two hours. Electrical circuitry for accomplishing this action is known in the art. For example, see issued U.S. Pat. No. 4,155,291, issued May 22, 1979, to Ryckman, Jr. et al., the disclosure of which is incorporated herein by reference.

The cup/decanter warmers are secured, stable, and sturdy in the extended locking positions whether each cup/decanter warmer is operating for single or dual usage for warming two decanters, or a decanter and two cups or even three decanters on each warmer, or any variety of these combinations. Once the cup/decanter warmers are cool, they can be securely retracted into the housing unit and fit securely in a contoured seamless side-seam base of the automatic coffee maker and are only viewed once opened by a push of a button for single or dual usage.

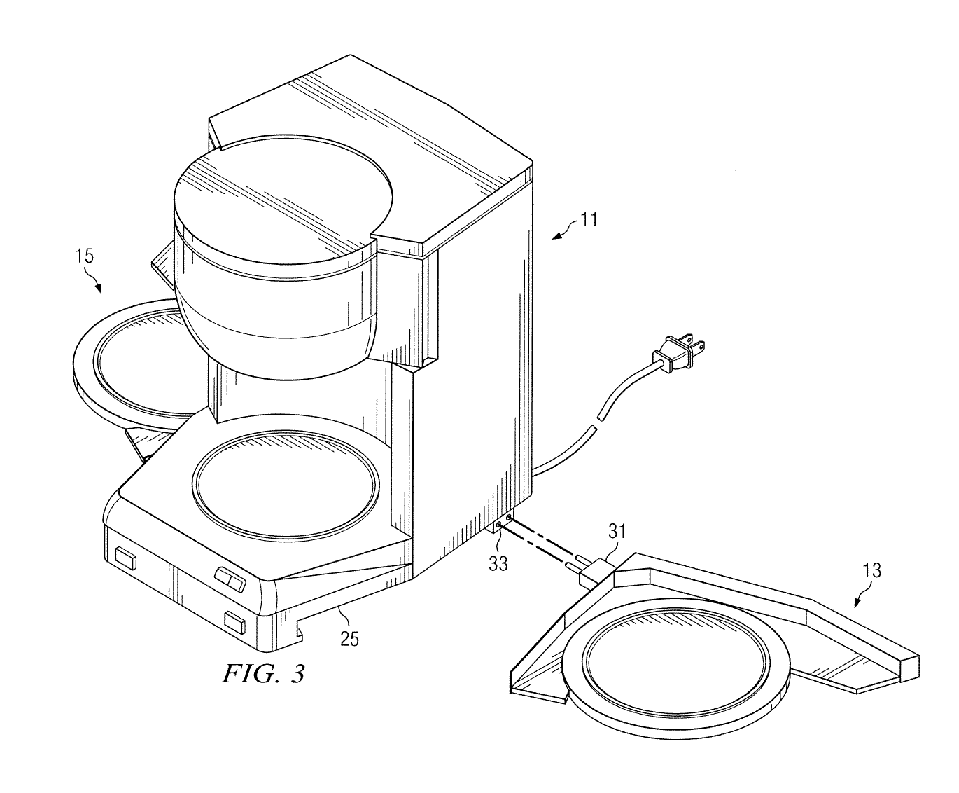

As illustrated in FIG. 3, the cup/decanter warmers, such as warmer 13, may be detachable from the main coffee brewing base. This can be accomplished in any convenient manner, for example, by providing a plug 31 on the warmer and a mating receptacle 33 on the base of the coffee machine. The detached warmer would obviously not have power supplied, but would help to keep a coffee cup or decanter warm for several minutes.

An invention has been provided with several advantages. In a typical operation, one can use the Automatic Coffee Maker With Cup Warmer(s) (aka)—also known as automatic coffee maker with cup/decanter warmers(s) in a variety of different situations. When desired, the user can use the device of the invention for single or dual use for warming cups during brewing and/or after the brewing cycle. The cup/decanter warmers will typically keep a user's coffee or liquid hot on the cup/decanter warmer for an extended period of time, for example two hours, and then will automatically turn off. In addition, the cup/decanter warmers can continue warming for longer periods by extending the warming time by a push of a button. During large gatherings, whether in the household, at a business, or a corporation office, the user can heat several decanters at a time and/or warm several cups at a time. The user can access three warmers and heat three decanters at a time. These unique features give the user longer lasting hot cups of coffee by accessing the cup/decanter warmer at any point for an uninterrupted hot cup of coffee. The non-stick surface of the cup/decanter warmer prevents the cups/decanters from sticking to the surface of the warmers and gives easy cleaning access.

While the invention has been shown in only one of its forms, it is not thus limited but is susceptible to various changes and modifications without departing from the spirit thereof.

I claim:

1. An improved coffee making machine, the machine comprising:
a coffee brewing base having a central warmer and a tower portion for dispensing brewed coffee through a filter and into a decanter located on the central warmer;
a power source for providing electrical power to the base and to the tower portion and to the central warmer;
at least one retractable cup/decanter warmer which is slidable between a closed position totally concealed within the base and a warming position which is visible and extended from the base;
wherein the retractable cup/decanter warmer can be securely locked into position in the warming position, which then allows at least one heating element located on the warmer to engage with the power source to provide heating to a cup or decanter of coffee present on the warmer.

2. The improved coffee maker of claim 1, wherein the left-side and right-side warmers are secured with the heating elements engaged only when the warmers are fully extended and secured by a suitable locking mechanism which serves to lock-in-place the retractable warmers.

3. The improved coffee maker of claim 2, wherein the cup/decanter warmers are circumferentially mounted within a casing which contours to the shape of the coffee maker and are housed in either side of the base of the coffee maker by means of seamless side-seams.

4. The improved coffee maker of claim 3, wherein the cup/decanter warmers are only viewed once they are moved to an open position by the push of a button for single or dual usage.

5. The improved coffee maker of claim 4, wherein these features allow a user to warm cups of coffee during brewing and after the brewing cycle, thereby allowing the user to keep coffee or other liquids hot in one or more decanters after brewing.

6. The improved coffee maker of claim 5, wherein these features allow the user either single or dual cup warming, and single or dual decanter warming during and after brewing.

7. The improved coffee maker of claim 6, wherein the cup/decanter warmers will only securely retract into the base of the coffee maker after the heating elements are cool, this action serving to tighten and secure the retractable warmers in the base of the coffee making machine where they are safely stored.

8. The improved coffee maker of claim 7, wherein the cup/decanter warmers are detachable from the coffee machine base.
